(19) United States
(12) Patent Application Publication
(10) Pub. No.: US 2020/0186299 A1
(43) Pub. Date: Jun. 11, 2020

(54) METHOD AND APPARATUS

(71) Applicant: Nokia Technologies Oy, Espoo (FI)

(72) Inventors: Timo Erkki Lunttila, Espoo (FI); Juha Sakari Korhonen, Espoo (FI); Karol Schober, Helsinki (FI)

(21) Appl. No.: 16/627,244

(22) PCT Filed: Jun. 30, 2017
(86) PCT No.: PCT/EP2017/066301

§ 371 Date: Dec. 27, 2019

(51) Int. Cl. H04L 1/18; H04L 5/00

(52) U.S. Cl. CPC H04L 1/1854; H04L 5/0055; H04L 1/1861; H04L 5/0082; H04L 1/1812

(57) ABSTRACT

A method comprises transmitting from a user device information on first and second hybrid automatic request acknowledgement bits and a scheduling request in a same transmission time interval. The information on said first and second hybrid automatic request acknowledgement bits and said scheduling request are transmitted via first and second physical resource blocks using one or more resources of a set of resources. At least one of the resources of the set of resources differs from the one or more resources of the set of resources used to transmit information on the first and second hybrid automatic request acknowledgement bits when there is no scheduling request.

### FIELD

This disclosure relates to a method and apparatus, and in particular but not exclusively to a method and apparatus used for transmitting HARQ-ACK (hybrid automatic request acknowledgement) and a method and apparatus for receiving HARQ-ACKs.

### BACKGROUND

A communication system can be seen as a facility that enables communication between two or more devices such as user terminals, machine-like terminals, base stations and/or other nodes by providing carriers between the communication devices. A communication system can be provided for example by means of a communication network and one or more compatible communication devices. The communication may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless system at least a part of communications between at least two stations occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename Wi-Fi. Wi-Fi is often used synonymously with WLAN.

The wireless systems can be divided into cells, and are therefore often referred to as cellular systems. A user can access a communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

A communication system and associated devices typically operate in accordance with a given standard or specification which sets out what the various entities associated with the system are permitted to do and how that should be achieved. Communication protocols and/or parameters which shall be used for the connection are also typically defined. Examples of standardised radio access technologies include GSM (Global System for Mobile), EDGE (Enhanced Data for GSM Evolution) Radio Access Networks (GERAN), Universal Terrestrial Radio Access Networks (UTRAN) and evolved UTRAN (E-UTRAN). An example of standardized communication system architectures is the long-term evolution (LTE) of the Universal Mobile Telecommunications System (UMTS) radio-access technology. The LTE is being standardized by the 3rd Generation Partnership Project (3GPP). The LTE employs the Evolved Universal Terrestrial Radio Access Network (E-UTRAN) access. Further developments of LTE are sometimes referred to as LTE Advanced (LTE-A).

### SUMMARY

According to an aspect, there is provided a method comprising: causing information on first and second HARQ-ACK bits and a scheduling request to be transmitted in a same transmission time interval, wherein said information on said first and second HARQ-ACK bits and said scheduling request are transmitted via first and second physical resource blocks using one or more resources of a set of resources, wherein at least one of said resources of said set of resources differs from the one or more resources of the set of resources used to transmit information on said first and second HARQ-ACK bits when there is no scheduling request.

The set of resources may comprise seven or less resources.

The method may comprise selecting a resource for each of said first and second physical resource blocks.

A different resource may be selected for each of said first and second physical resource blocks.

A same resource may be selected for each of said first and second physical resource blocks.

The method may comprise performing a logical operation on said first and second HARQ-ACK bits and in dependence on said logical operation selecting a respective resource.

The method may comprise performing a logical operation on said first and second HARQ-ACK bits and in dependence on said logical operation selecting either a respective resource or the scheduling request.

The logical operation may comprise an AND operation.

The method may comprise selecting a plurality of resources for at least one of said physical resource blocks.

Selection of a predefined one of the plurality of resources may indicate a presence of a scheduling request.

The transmission time interval may comprise a short transmission time interval.

The transmission time interval may comprise one of two and three symbols.

The method may comprise receiving scheduling request configuration information.

The method may comprise receiving information on a plurality of sets of resources for HARQ-ACK transmission.

The method may comprise receiving information indicating which of said plurality of sets of resources is to be used.

According to a second aspect, there is provided a method comprising: causing information on first and second HARQ-ACK bits and a scheduling request to be transmitted in a same transmission time interval.

Information on said first and second HARQ-ACK bits and said scheduling request may be transmitted via first and second physical resource blocks using one or more resources of a set of resources.

At least one of said resources of said set of resources may differ from the one or more resources of the set of resources used to transmit information on said first and second HARQ-ACK bits when there is no scheduling request.

Additionally, or alternatively, one or more of the features of the first aspect may be provided with any one or more of the features of the second aspect.

According to a third aspect, there is provided a method comprising: receiving information on first and second HARQ-ACK bits and a scheduling request in a same transmission time interval, wherein said information on said first and second HARQ-ACK bits and said scheduling request are received via first and second physical resource blocks using one or more resources of a set of resources, wherein at least one of said resources of said set of resources differs from the one or more resources of the set of resources used to provide information on said first and second HARQ-ACK bits when there is no scheduling request.

The set of resources may comprise seven or less resources.

A different resource may be used on each of said first and second physical resource blocks.

A same resource may be used on each of said first and second physical resource blocks.

A predefined one of a plurality of resources may indicate a presence of a scheduling request.

The transmission time interval may comprise a short transmission time interval.

The transmission time interval may comprise one of two and three symbols.

The method may comprise causing scheduling request configuration information to be transmitted.

The method may comprise causing information on a plurality of sets of resources for HARQ-ACK transmission to be transmitted.

The method may comprise causing information indicating which of said plurality of sets of resources is to be used to be transmitted.

According to a fourth aspect, there is provided a method comprising: receiving information on first and second HARQ-ACK bits and a scheduling request in a same transmission time interval.

The information on said first and second HARQ-ACK bits and said scheduling request may be received via first and second physical resource blocks using one or more resources of a set of resources.

At least one of said resources of said set of resources may differ from the one or more resources of the set of resources used to provide information on said first and second HARQ-ACK bits when there is no scheduling request.

Additionally, or alternatively, one or more of the features of the third aspect may be provided with any one or more of the features of the fourth aspect

According to a fifth aspect, there is provided an apparatus in a communication device, the apparatus comprising at least one processor, and at least one memory including computer program code, wherein the at least one memory and the computer program code are configured, with the at least one processor, to: cause information on first and second HARQ-ACK bits and a scheduling request to be transmitted in a same transmission time interval, wherein said information on said first and second HARQ-ACK bits and said scheduling request are transmitted via first and second physical resource blocks using one or more resources of a set of resources, wherein at least one of said resources of said set of resources differs from the one or more resources of the set of resources used to transmit information on said first and second HARQ-ACK bits when there is no scheduling request.

The set of resources may comprise seven or less resources.

The at least one memory and the computer code may be configured with the at least one processor to select a resource for each of said first and second physical resource blocks.

A different resource may be selected for each of said first and second physical resource blocks.

A same resource may be selected for each of said first and second physical resource blocks.

The at least one memory and the computer code may be configured with the at least one processor to perform a logical operation on said first and second HARQ-ACK bits and in dependence on said logical operation selecting a respective resource.

The at least one memory and the computer code may be configured with the at least one processor to perform a logical operation on said first and second HARQ-ACK bits and in dependence on said logical operation selecting either a respective resource or the scheduling request.

The logical operation may comprise an AND operation.

The at least one memory and the computer code may be configured with the at least one processor to select a plurality of resources for at least one of said physical resource blocks.

Selection of a predefined one of the plurality of resources may indicate a presence of a scheduling request.

The transmission time interval may comprise a short transmission time interval.

The transmission time interval may comprise one of two and three symbols.

The at least one memory and the computer code may be configured with the at least one processor to receive scheduling request configuration information.

The at least one memory and the computer code may be configured with the at least one processor to receive information on a plurality of sets of resources for HARQ-ACK transmission.

The at least one memory and the computer code may be configured with the at least one processor to receive information indicating which of said plurality of sets of resources is to be used.

According to a sixth aspect, there is provided an apparatus in a communication device, the apparatus comprising at least one processor, and at least one memory including computer program code, wherein the at least one memory and the computer program code are configured, with the at least one processor, to: cause information on first and second HARQ-ACK bits and a scheduling request to be transmitted in a same transmission time interval.

The information on said first and second HARQ-ACK bits and said scheduling request may be transmitted via first and second physical resource blocks using one or more resources of a set of resources.

At least one of said resources of said set of resources may differ from the one or more resources of the set of resources used to transmit information on said first and second HARQ-ACK bits when there is no scheduling request.

Additionally, or alternatively, one or more of the features of the fifth aspect may be provided with any one or more of the features of the sixth aspect

According to a seventh aspect, there is provided an apparatus in an access point, the apparatus comprising at least one processor, and at least one memory including computer program code, wherein the at least one memory and the computer program code are configured, with the at least one processor, to: receive information on first and second HARQ-ACK bits and a scheduling request in a same transmission time interval, wherein said information on said first and second HARQ-ACK bits and said scheduling request are received via first and second physical resource blocks using one or more resources of a set of resources, wherein at least one of said resources of said set of resources differs from the one or more resources of the set of resources used to provide information on said first and second HARQ-ACK bits when there is no scheduling request.

The set of resources may comprise seven or less resources.

A different resource may be used on each of said first and second physical resource blocks.

A same resource may be used on each of said first and second physical resource blocks.

A predefined one of a plurality of resources may indicate a presence of a scheduling request.

The transmission time interval may comprise a short transmission time interval.

The transmission time interval may comprise one of two and three symbols.

The at least one memory and the computer code may be configured with the at least one processor to schedule request configuration information to be transmitted.

The at least one memory and the computer code may be configured with the at least one processor to cause information on a plurality of sets of resources for HARQ-ACK transmission to be transmitted.

The at least one memory and the computer code may be configured with the at least one processor to cause information indicating which of said plurality of sets of resources is to be used to be transmitted.

According to an eighth aspect, there is provided an apparatus in an access point, the apparatus comprising at least one processor, and at least one memory including computer program code, wherein the at least one memory and the computer program code are configured, with the at least one processor, to: receive information on first and second HARQ-ACK bits and a scheduling request in a same transmission time interval.

The information on said first and second HARQ-ACK bits and said scheduling request may be received via first and second physical resource blocks using one or more resources of a set of resources.

At least one of said resources of said set of resources may differ from the one or more resources of the set of resources used to provide information on said first and second HARQ-ACK bits when there is no scheduling request.

Additionally, or alternatively, one or more of the features of the seventh aspect may be provided with any one or more of the features of the eighth aspect

A computer program comprising program code means adapted to perform the herein described methods may also be provided. In accordance with further embodiments apparatus and/or computer program product that can be embodied on a computer readable medium for providing at least one of the above methods is provided.

Various other aspects and further embodiments are also described in the following detailed description of examples embodying the invention and in the attached claims.

### BRIEF DESCRIPTION OF FIGURES

Some embodiments will now be described in further detail, by way of example only, with reference to the following examples and accompanying drawings, in which:

FIG. 1 shows a schematic example of a system where the invention may be implemented;

FIG. 2 shows an example of a communication device;

FIG. 3 shows a method of an embodiment performed in an apparatus of a user device;

FIGS. 4 to 9 show tables with different examples of using up to 6 six resources to transmit two HARQ-ACK bits and a one bit scheduling request;

FIG. 10 shows a previous proposal for transmitting two HARQ-ACK bits;

FIG. 11 shows a method of an embodiment performed by an apparatus in or associated with a base station; and

FIG. 12 shows a control apparatus.

### DETAILED DESCRIPTION OF EMBODIMENTS

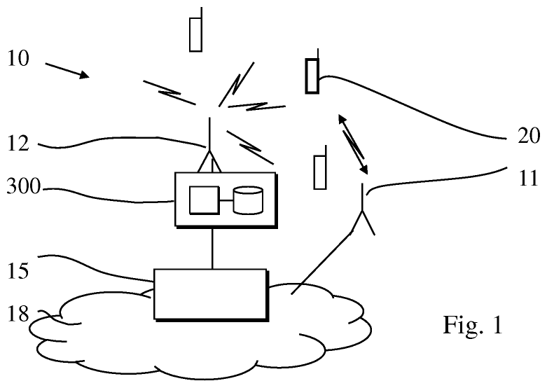

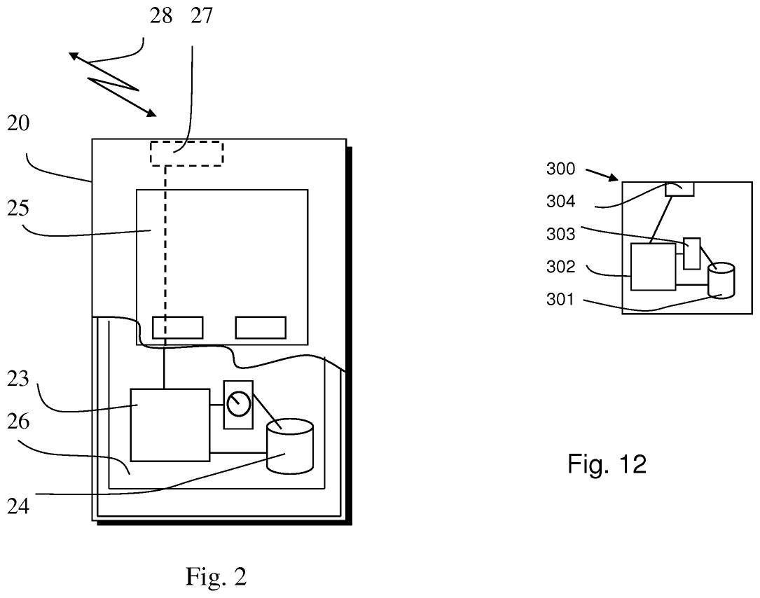

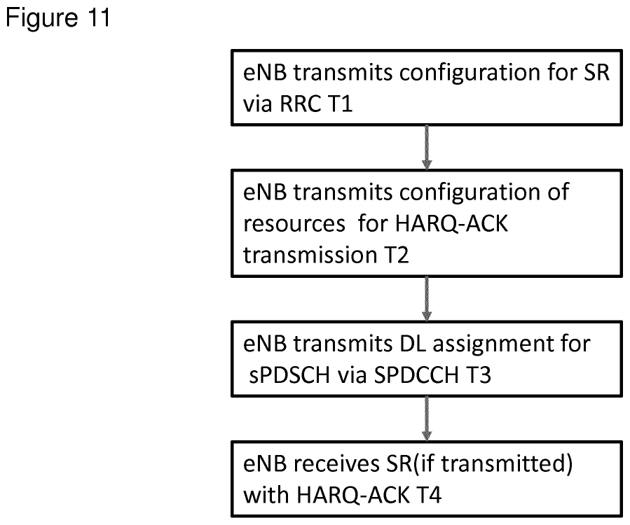

In the following certain exemplifying embodiments are explained with reference to a wireless communication system serving devices adapted for wireless communication. Therefore, before explaining in detail the exemplifying embodiments, certain general principles of a wireless system, components thereof, and devices for wireless communication are briefly explained with reference to system 10 of FIG. 1, device 20 of FIG. 2 and apparatus of FIG. 11, to assist in understanding the described examples.

A communication device can be used for accessing various services and/or applications provided via a communication system. In wireless communication systems the access is provided via a wireless access interface between wireless communication devices and an appropriate access system. A device may access wirelessly a communication system via a base station. A base station site can provide one or more cells of a cellular system. In the FIG. 1 example, a base station 12 can provide e.g. three cells on different carriers. In addition to the base station 12, at least one serving cell can also be provided by means of another station or stations. For example, at least one of the carriers may be provided by a station that is not co-located at base station 12. This possibility is denoted by station 11 in FIG. 1. Interaction between the different stations and/or controllers thereof can be arranged in various manners. Each mobile device 20 and base station may have one or more radio channels open at the same time and may receive signals from more than one source.

A base station node can be connected to a data network 18 via an appropriate gateway 15. A gateway function between the access system and another network such as a packet data network may be provided by means of any appropriate gateway node, for example a packet data gateway and/or an access gateway. A communication system may thus be provided by one or more interconnect networks and the elements thereof, and one or more gateway nodes may be provided for interconnecting various networks.

FIG. 2 shows a schematic, partially sectioned view of a communication device 20 that a user can use for communications. Such a communication device is often referred to as user equipment (UE) or terminal. An appropriate communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia, positioning data, other data, and so on. Users may thus be offered and provided numerous services via their communication devices. Non-limiting examples of these services include two-way or multi-way calls, data communication or multimedia services or simply an access to a data communications network system, such as the Internet.

A mobile device is typically provided with at least one data processing entity 23, at least one memory 24 and other possible components 29 for use in software and hardware aided execution of tasks it is designed to perform, including control of access to and communications via base stations and/or other user terminals. The data processing, storage and other relevant control apparatus can be provided on an appropriate circuit board and/or in chipsets. This apparatus is denoted by reference 26.

A user may control the operation of the device 20 by means of a suitable user interface such as key pad, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

The device 20 may receive and transmit signals 28 via appropriate apparatus for receiving and transmitting signals. In FIG. 2 transceiver apparatus is designated schematically by block 27. The transceiver apparatus may be provided with cognitive radio capability. The transceiver may be provided for example by means of a radio part and associated antenna arrangement. The antenna arrangement may be arranged internally or externally to the mobile device.

The communication device can access a communication system based on various access techniques, for example those based on the third Generation Partnership Project (3GPP) specifications. Some embodiments may be provided in the LTE-Advanced Pro system, which will be part of 3GPP LTE Rel-15. Of course, other embodiments may be provided in the context of other standards. A base station is referred to as an eNodeB in the context of LTE.

FIG. 12 shows an example of an apparatus 300 provided in or associated with a base station, as shown in FIG. 1.The apparatus comprises at least one memory 301, at least one data processing unit or at least one data processor 302, 303 and an input/output interface 304. Via the interface the apparatus can be coupled to a receiver and a transmitter of the base station.

Some embodiments may aim to reduce latency. Some embodiments may be provided in the context of “New Work Item on shortened TTI (sTTI) and processing time for LTE”—RP-161299.

Reference will be made to two frame structures of LTE: type 1 and type 2. Type 1 supports FDD (frequency division multiplexing). Type 2 supports TDD (time division multiplexing). Some embodiments can be used with either of both of these frame structures.

RP-161299 suggests the following for frame structure type 1:

support for a transmission duration based on a 2-symbol sTTI and 1-slot sTTI for sPDSCH (short physical downlink shared channel)/sPDCCH (short physical downlink control channel); and

support for a transmission duration based on 2-symbol sTTI, 4-symbol sTTI, and 1-slot sTTI for sPUCCH (short physical uplink control channel)/sPUSCH (short physical uplink shared channel).

RP-161299 suggests the following for frame structure type 2:

support for a transmission duration based on 1-slot sTTI for sPDSCH /sPDCCH/sPUSCH/sPUCCH.

In some embodiments, the sequence-based sPUCCH without a DMRS (demodulation reference signal) is supported for up to two HARQ-ACK (HARQ—hybrid automatic request acknowledgement) bits in 2OS (2 symbols) sTTI and 3OS (3 symbols) sTTI.

In some embodiments, the ACK/NACK (negative ACK) information maps to different cyclic shifts (i.e., ACK and NACK are indicated based on a cyclic shift index).

In some embodiments, the cyclic shifts on different sPUCCH symbols may be different due to cyclic shift randomization.

Cyclic shift randomization may be re-used from 1 ms operation to support multiplexing with legacy PUCCH.

In some embodiments, only frequency hopping between sPUCCH symbol(s) is supported.

Short PUCCH is a PUCCH structure occupying a few symbols (such as 4 symbols). Short PUCCH may be time-domain multiplexed with the PUSCH (physical uplink shared channel).

In some embodiments, there is one PRB (physical resource block) allocation per symbol.

In some embodiments, a sequence-based PUCCH is used to carry a 2-bit payload in 2/3OS sTTI. Some embodiments address the handling of a SR (scheduling request) together with HARQ-ACK bits.

Some embodiments provide methods for signalling HARQ-ACK information together with a SR when using sequence based sPUCCH for a 2 or 3 symbol sTTI.

A sequence based sPUCCH makes use of computer generated length-12 sequences, which are also used e.g. as demodulation reference signals in LTE. In other embodiments, different length sequences may be used. More specifically, 2 (for 1-bit HARQ-ACK case) or 4 (for 2-bit HARQ ACK) cyclic shifts of a sequence represent the different possible values of HARQ ACK (0 or 1 for 1-bit case, 00, 01, 10, or 11 for the 2-bit case). The detection of the HARQ-ACK value can be non-coherent, i.e. there are no specific reference signals but instead the eNodeB can just compare the different received sequences and cyclic shifts, and the one with the largest received power (e.g. based on auto-correlation operation) can be selected. In other words, the eNodeB may test multiple (2 or 4) hypothesis each representing one or two bits, and choose the most likely one.

To ensure reliable detection of the correct sequence (or cyclic shift), all the sequences possibly carrying HARQ-ACK information may be located on the same physical resource block(s) (PRBs). Otherwise, if one sequence uses a different PRB than the other e.g. frequency domain fading to the channel could deteriorate the reliability of detecting which sequence was transmitted. Typically, it is assumed that 6 or 7 cyclic shifts of a sequence can remain sufficiently orthogonal (i.e. can be sufficiently distinguished) on a single PRB (i.e. one PRB may contain up to 6 or 7 resources). If a different sequence is used at each of the two PRBs, then diversity gain from frequency hopping not available. However this is only if the SR is to be transmitted. If no SR is to be transmitted, the diversity gain from frequency hopping is retained.

In sequence based signalling, the base station compares different sequences (cyclic shifts) and chooses the most likely one based on signal energy. If all sequences are on the same PRB, the channel affects the sequences equally and detection is reliable. If sequences are on different PRBs, channel fading may makes detection more complicated, but detection is still possible.

In sTTI operation, a SR only operation may utilize sequence based operation. However, since the SR only carries on/off type of information, a single resource (e.g. cyclic shift) may be sufficient (in case of a negative SR, nothing is transmitted). If a UE needs to transmit both HARQ-ACK and SR in the same sTTI, it may be desirable to avoid multi-cluster transmission and transmit both on the same PRB.

When multiplexing the HARQ-ACK with SR, the problem is that e.g. for the 2-bit HARQ ACK case, 3 bits of information need to be signalled. In principle, this requires 8 orthogonal resources, which usually may not be provided by a single PRB. In some embodiments, methods of signalling 2 HARQ-ACK bits with a scheduling request are provided.

By way of background, sequence-based PUCCH operates as the follows. The UE is pre-configured with X resources (cyclically shifted sequences) to transmit N bits, where each resource comprises a time-frequency resource such as a PRB-pair (PRB1 and PRB2 with frequency-hopping and transmitted without overlap in time) and a resource within the PRB-pair. X may be seven or less.

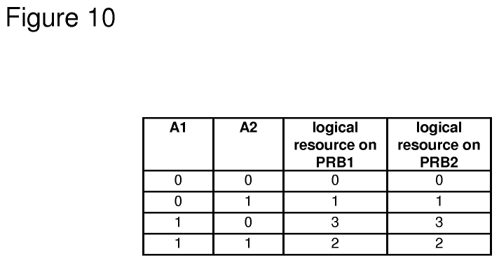

A resource may be a physical resource. The physical resource characterized in frequency domain as one or more physical resource blocks, in time domain as SC-FDMA or OFDM symbols or as a transmit time interval, and in code domain as cyclically shifted sequences, or other code, or as a combination thereof. A resource may include different physical resource blocks and/or different physical sequences in different SC-FDMA or OFDM symbols. A resource may be a logical resource. A resource is mapped to a physical sequence with a cyclic shift. The mapping between combinations of HARQ-ACK bits (A1, A2) and the resources is illustrated in the example in the table of FIG. 10. A1 and A2 may relate to for example different data transport blocks transmitted either on the same or different cells. A value of 1 may be an ACK and a value of 0 may be a NACK (or vice versa).

An eNB may inform the UE about which of the X pre-configured resources to use for ACK/NACK by the use of an explicit ACK resource indicator (ARI) in the DL assignment. In other embodiments, any other suitable mechanism for conveying to the UE which resources to use may be alternatively or additionally used. In other embodiments, the UE may have prior knowledge of the X resources.

The above sequence based scheme may be directly extended to transmitting 3 bits (A1, A2 and SR). However, this approach would require 8 resources to be pre-configured/reserved together with each PRB-pair, which may prevent the multiplexing of resources for multiple UEs on a given PRB resource. Reserving 8 resources might be considered to regard the SR bit equal to ACK/NACK bits although in practice UE may typically transmit SR only rarely. Alternatively or additionally, it may be difficult to distinguish between 8 resource on a PRB, since the cyclic shifts of sequences may not have sufficient separation and end up overlapping each other due to the delay spread of the propagation channel.

Some embodiments provide a method and apparatus for transmitting 3 bits of information (A1, A2 and SR) with 2/3 symbol short TTI using only 4-6 resources (e.g. cyclically shifted sequences) being reserved.

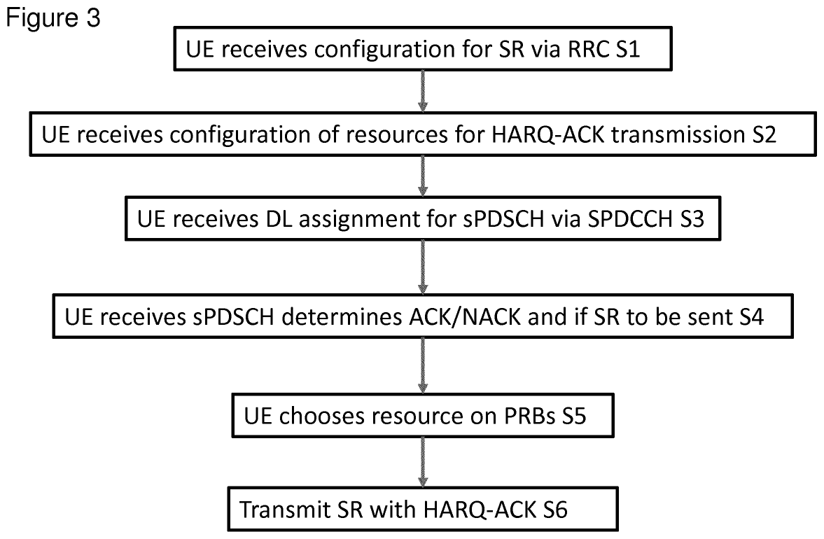

Reference is made to FIG. 3 which shows a method of some embodiments. This may be performed by an apparatus in the UE.

In step S1, the UE receives a configuration for a SR from the eNodeB. This may be for example via RRC (radio resource control) signalling or in any other suitable way.

This configuration may comprise one or more of:

the periodicity in time (e.g. every nth sTTI); a subframe offset; an index of the resource (which relates to a first and a second physical resource block (PRB1 and PRB2) in consecutive symbols; and cyclic shifts of sequences on each of the two PRBs for the SR-only transmission.

The configuration may allow the option of sending the SR with an ACK/NACK in any sTTI as well as allowing the SR to transmitted without an ACK/NACK in only some of sTTIs (e.g. with a configured periodicity). This may be provided in the configuration information provided to the UE.

In some embodiments, this step may be permitted if the UE has prior knowledge of the configuration or if the configuration is implicitly determined.

In step S2, the UE receives the configuration of the resources for the HARQ-ACK transmission. This may be received from the eNodeB. This configuration of resources may comprises, for example, four of sets of for example 5 or 6 resources configured for ACK/NACK and SR transmission. In other embodiments, more or less than four sets may be used. Each resource may comprise a first and a second physical resource block (PRB1 and PRB2) in consecutive symbols, as well as cyclic shifts of sequences on each of the two PRBs.

In some embodiments, this step may be permitted if the UE has prior knowledge of the configuration of the resources or if the configuration of resources is implicitly determined.

In step S3, the UE may receive a DL assignment for the sPDSCH via the sPDCCH from the eNodeB. The DL assignment may comprise, for example, a 2-bit ARI field (ACK/NACK Resource Indicator) indicating which one of the (four) sets of HARQ-ACK+SR resources the UE should use.

In some embodiments, the DL assignment may be implicitly determined or may be via any other suitable mechanism.

It should be appreciated that steps S1 to S3 may take place in any order. One or more of steps S1 to S3 may be combined. It should be appreciated that one or more of steps S1 to S3 may be omitted, as discussed previously.

In step S4, the UE receives the assigned sPDSCH. The UE may determines the ACK/NACK bits. The UE will determine whether to send also an SR. In other embodiments, a different channel may be received.

In step S5, the UE chooses the resources depending on whether the SR is to be transmitted with the HARQ-ACK or not. Various examples of this are now discussed.

If the SR is not transmitted with HARQ-ACK, depending on the values of HARQ-ACK bits, the UE may choose a resource on first PRB, PRB1 (for example a first, second, third, or fourth resource). The UE may uses the same resource also on the second PRB, PRB2.

If SR is transmitted with HARQ-ACK then one of the following options is used.

Option 1: The UE performs bundling (using logical AND operation) of HARQ-ACK bits, and depending on the outcome of bundling, selects an additional, fifth or sixth resource for PRB1.

In the following, various example tables are provided for different embodiments. A1 and A2 refer to the HARQ-ACK bits with the associated values. SR refers to whether there is a scheduling request (1) or not (0). The bundled A/N refers to the bundling of the

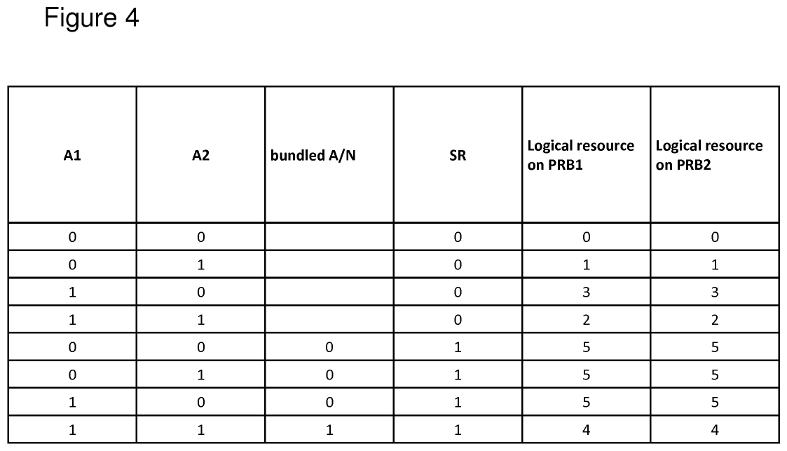

One example of option 1 is shown in the table of FIG. 4 where there is ACK/NACK bundling on PRB2 when SR is present, with a single physical sequence being transmitted on a physical resource (6 resources reserved). Both the 5th and the 6th resource may be indicated with the ARI. The table of FIG. 4 shows that two additional resources, 4 and 5 (fifth and sixth resources), are employed when SR is to be transmitted. When bundled HARQ-ACK is ACK then the resource 4 is chosen and when the bundled HARQ-ACK is NACK, the resource 5 is chosen. It should be appreciated that the numbering of the resources is by way of example only and different numbering of resources may be used in different embodiments.

This option preserves the diversity gain of frequency hopping as the information transmitted on different PRBs is duplicated.

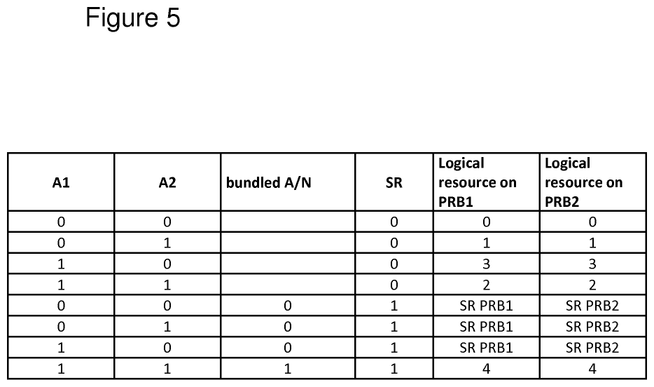

Another example of option 1 is shown in the table of FIG. 5. The table of FIG. 5 shows an example similar to the table of FIG. 4.This table has ACK /NACK bundling on the second PRB, PRB2 when a SR is present and uses a SR RB resource instead of one logical sequence. A single physical sequence is transmitted on a physical resource (5 sequences being reserved). The difference as compared to the table of FIG. 4 is that when a SR is transmitted, and if the bundled HARQ-ACK is NACK then the UE transmits SR on the separate resource for SR-only transmission. Thus only the fifth resource (resource 4) is indicated with ARI, while the sixth resource is the one used for SR transmission without HARQ-ACK. In this option, only five sequences need to be reserved. This option also preserves the frequency diversity.

In the first option, the UE may use the same resources on both of the PRBS, PRB1 and PRB2.

Alternatively, a second option may be used where the UE selects a different resource for the second PRB, PRB2 than for the first PRB, PRB1.

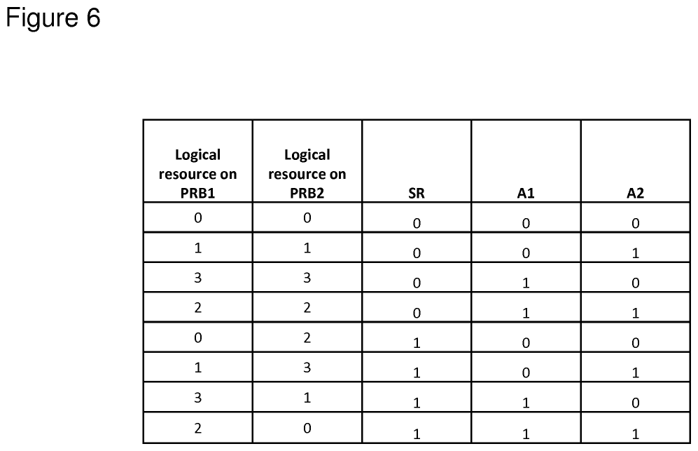

A first example of the second option will now be described. Depending on the values of HARQ-ACK bits (and irrespective of whether SR is transmitted), the UE chooses a resource on the first PRB, PRB1 (a first, second, third, or fourth resource). The resource on the second PRB, PRB2 is one of the four resources that the UE has not chosen for HARQ-ACK transmission on PRB1. In this regard, reference is made to the table of FIG. 6. The table of FIG. 6 thus shows an example where a different resource is transmitted on the first PRB, PRB1 and the second PRB, PRB2, if a SR is transmitted. It should be noted that if no SR is transmitted, a usual use of resources (such is in the examples of FIGS. 4 and 5) may be used. This example may have a single physical sequence transmitted on a physical resource, with four sequences being reserved. An advantage is that only four resources need to be reserved. No HARQ-ACK bundling is used in this embodiment.

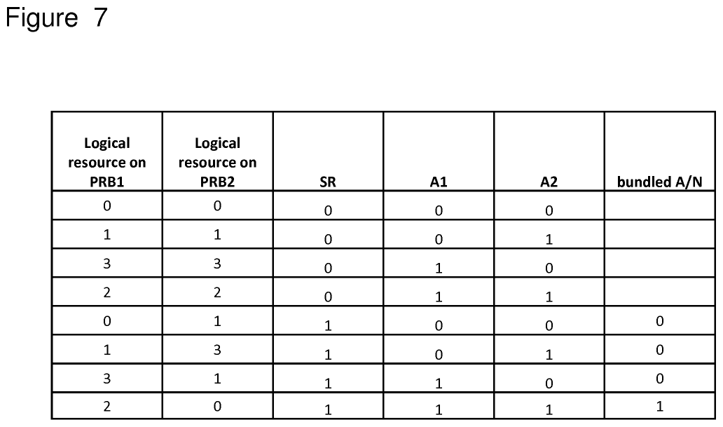

A second example of the second option will be described with reference to the table of FIG. 7. The table of FIG. 7 shows an example similar to the one in FIG. 6, but the HARQ-ACK bits are bundled. Thus the table of FIG. 7 shows ACK/NACK bundling on the second PRB, PRB2 when a SR is present, a single physical sequence being transmitted on a physical resource (four sequences being reserved). Thus, in this example, bundling is applied i.e. a logical AND operation is to the two HARQ-ACK bits such that only one HARQ-ACK bit is transmitted on the second PRB, PRB2.

In a third option, the UE selects an additional resource on the first PRB, PRB1, i.e. UE transmits two resources on a PRB.

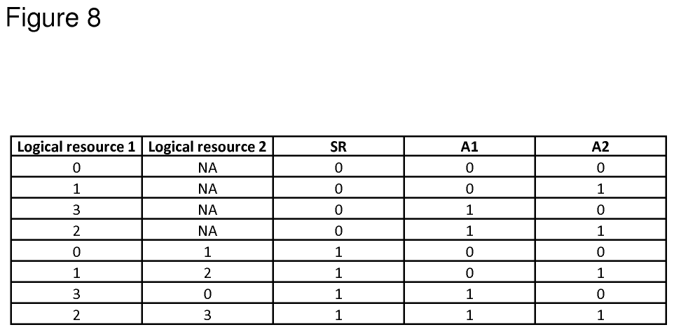

A first example of the third option is shown in the table of FIG. 8. The additional resource may be one of the four resources that the UE has not chosen for HARQ-ACK transmission. The table of FIG. 8 shows an example where the diversity of frequency hopping is preserved, but the SR is transmitted by transmitting additional resource on the same PRB. The same resources are transmitted on both the PRBS, PRB1 and PRB 2. One resource is used where there is no SR and two resources are used where there is a SR. This option uses only four resources, and when the SR is transmitted, the power between two transmitted resources may be shared. This may result in a 3 dB loss. However, if not power limited (i.e. operating below its maximum power), a UE may boost the power in this case to compensate for the loss. Thus the example of FIG. 8 has no ACK/NACK bundling and multiple physical sequences are transmitted on a physical resource (four sequences are reserved)

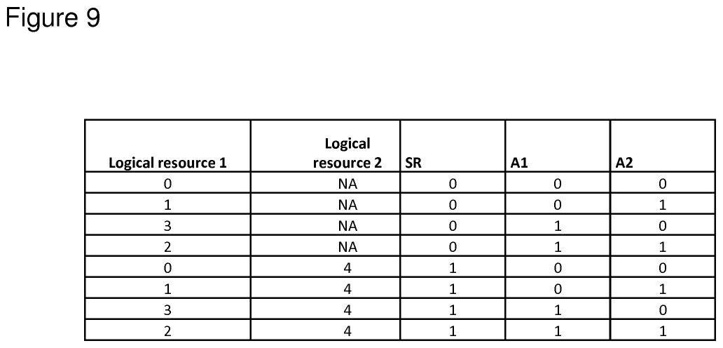

In a second example of the third option, the additional resource may be an additional, fifth resource. This is shown in the table of FIG. 9. The UE uses the same resources on both the first and second PRBs, PRB1 and PRB2. The table of FIG. 9 shows an example which is similar as the one in FIG. 8, but where the additional fifth resource, if transmitted, indicates the presence of a SR. This may be simpler to detect. If the resource 1 is not detected, but resource 2 is detected, an eNB knows that HARQ-ACK bits are lost, but SR was correctly received. This contrasts with the previous example where if only resource 2 is detected, the HARQ-ACK bits are wrongly received. Thus the arrangement of FIG. 9 has no ACK/NACK bundling, and multiple logical sequences are transmitted on a physical resource (five sequences being reserved)

Finally going back to the method of FIG. 3, in step S6, the UE transmits HARQ-ACK and SR using the selected resource(s) on PRB1 and PRB2

In some embodiments, in the case when the UE transmits both HARQ-ACK(s) and SR, the transmit power may be increased compared to HARQ-ACK-only (or SR-only) transmission by e.g. 3 dB.

As discussed previously, an extension of sequence based sPUCCH to support three bits is possible. However 8 cyclic shifts do not usually remain orthogonal on a single PRB.

Reference is made to FIG. 11 which shows for the method of FIG. 3, the method performed in an apparatus of the eNB. This may be for example performed in the apparatus shown in FIG. 12.

In step T1, the eNodeB transmits the configuration for the SR to the UE. This may be for example via RRC (radio resource control) signalling. The configuration may be as previously described.

In step T2, the eNodeB transmits the configuration of the resources for the HARQ-ACK transmission to the UE.

In step T3, the eNodeB transmits a DL assignment for the sPDSCH via the sPDCCH to the UE.

One or more of steps T1 to T3 may be combined. One or more of steps T1 to T3 may be omitted. The steps of T1 to T3 may take place in any order.

In step T4, the eNodeB receives from the UE, the HARQ-ACK and SR with the selected resource(s) on the first and second PRBS, PRB1 and PRB2.

The detection of the HARQ-ACK values and optional the SR value can be non-coherent as discussed above. That is there are no specific reference signals but instead the eNodeB can just compare the different received sequences and cyclic shifts, and the one with the largest received power (e.g. based on auto-correlation operation) can be selected. The eNodeB may test multiple hypothesis each representing one of the possible combinations in the respective table, and choose the most likely one.

The previously described embodiments require less than seven resources to be reserved which may be reliably distinguished by an eNodeB. Some embodiments may use seven resources. When a SR is not transmitted, there is generally no or only a minor impact on the performance of HARQ-ACK feedback, depending on the embodiment in question. In some embodiments, the possibility of transmitting a SR with HARQ-ACK bits provides additional opportunities to send an SR, and decreases the latency if a UE has DL traffic.

It is noted that the above discussed issues are not limited to any particular communication environment, but may occur in any appropriate communication system.

In particular, the example context outlined in the LTE documentation is only one example of a context in which some embodiments may be provided. Different embodiments may be provided in different LTE contexts.

Different embodiments may use TTIs provided on channels other than the previously described embodiments.

Other embodiments may be provided in non LTE contexts and may be in the context of any other suitable standard. Some embodiments may be applied to feedback of HARQ-ACK and SR in 5G radio systems, also known as New Radio, when using uplink control channels short PUCCH, or long PUCCH.

The required data processing apparatus and functions may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory. One or more of the steps discussed in relation to FIGS. 3 and 11 may be performed by one or more processors in conjunction with one or more memories.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is noted that whilst embodiments have been described in relation to certain architectures, similar principles can be applied to other systems. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1-19. (canceled)

20. A method comprising:
causing information on first and second hybrid automatic request acknowledgement bits and a scheduling request to be transmitted in a same transmission time interval, wherein said information on said first and second hybrid automatic request acknowledgement bits and said scheduling request are transmitted via first and second physical resource blocks using one or more resources of a set of resources, wherein at least one of said resources of said set of resources differs from the one or more resources of the set of resources used to transmit information on said first and second hybrid automatic request acknowledgement bits when there is no scheduling request.

21. A method as claimed in claim 20, wherein said set of resources comprises seven or less resources.

22. A method as claimed in claim 20, comprising selecting a resource for each of said first and second physical resource blocks.

23. A method as claimed in claim 22, wherein a different resource is selected for each of said first and second physical resource blocks.

24. A method as claimed in claim 22, wherein a same resource is selected for each of said first and second physical resource blocks.

25. A method as claimed in claim 20, comprising performing a logical operation on said first and second hybrid automatic request acknowledgement bits and in dependence on said logical operation selecting a respective resource.

26. A method as claimed in claim 20, comprising performing a logical operation on said first and second hybrid automatic request acknowledgement bits and in dependence on said logical operation selecting either a respective resource or the resource configured for scheduling request transmission.

27. A method as claimed in claim 25, wherein said logical operation comprises an AND operation.

28. A method as claimed in claim 20, comprising selecting a plurality of resources for at least one of said physical resource blocks.

29. A method as claimed in claim 28, wherein selection of a predefined one of the plurality of resources indicates a presence of a scheduling request.

30. A method as claimed in claim 20, wherein said transmission time interval comprises a short transmission time interval.

31. A method as claimed in claim 20, wherein said transmission time interval comprises one of two and three symbols.

32. A method as claimed in claim 20, comprising receiving scheduling request configuration information.

33. A method as claimed in claim 20, comprising receiving information on a plurality of sets of resources for hybrid automatic request acknowledgement transmission.

34. A method as claimed in claim 33, comprising receiving information indicating which of said plurality of sets of resources is to be used.

35. A method comprising:
receiving information on first and second hybrid automatic request acknowledgement bits and a scheduling request transmitted in a same transmission time interval, wherein said information on said first and second hybrid automatic request acknowledgement bits and said scheduling request are received via first and second physical resource blocks using one or more resources of a set of resources, wherein at least one of said resources of said set of resources differs from the one or more resources of the set of resources used to provide information on said first and second hybrid automatic request acknowledgement bits when there is no scheduling request.

36. A computer program comprising program code means adapted to perform the steps of claim 20 when the program is run on a data processing apparatus.

37. An apparatus in a communication device, the apparatus comprising at least one processor, and at least one memory including computer program code, wherein the at least one memory and the computer program code are configured, with the at least one processor, to:
cause information on first and second hybrid automatic request acknowledgement bits and a scheduling request to be transmitted in a same transmission time interval, wherein said information on said first and second hybrid automatic request acknowledgement bits and said scheduling request are transmitted via first and second physical resource blocks using one or more resources of a set of resources, wherein at least one of said resources of said set of resources differs from the one or more resources of the set of resources used to transmit information on said first and second HARQ-ACK bits when there is no scheduling request.

38. An apparatus in an access point, the apparatus comprising at least one processor, and at least one memory including computer program code, wherein the at least one memory and the computer program code are configured, with the at least one processor, to:
receive information on first and second hybrid automatic request acknowledgement bits and a scheduling request in a same transmission time interval, wherein said information on said first and second hybrid automatic request acknowledgement bits and said scheduling request are received via first and second physical resource blocks using one or more resources of a set of resources, wherein at least one of said resources of said set of resources differs from the one or more resources of the set of resources used to provide information on said first and second hybrid automatic request acknowledgement bits when there is no scheduling request.
